(19) United States
(12) Patent Application Publication
(10) Pub. No.: US 2002/0154441 A1
(43) Pub. Date: Oct. 24, 2002

(54) Disc drive with grooves on internal surfaces

(76) Inventors: Srinivas Tadepalli, Eden Prairie, MN (US); Ram Rao, Roseville, MN (US)

Correspondence Address: Theodore M. Magee, WESTMAN CHAMPLIN & KELLY, International Centre - Suite 1600, 900 South Second Avenue, Minneapolis, MN, 55402-3319, US

(21) Appl. No.: 10/053,271

(22) Filed: Jan. 17, 2002

Related U.S. Application Data
(60) Provisional application No. 60/285,511, filed on Apr. 20, 2001.

(51) Int. Cl. G11B 17/02

(52) U.S. Cl. 360/97.02

(57) ABSTRACT

A data storage device for storing and accessing data includes a motor and at least one movable medium coupled to the motor. The motor is capable of moving the medium and thereby generating turbulent airflow. The data storage device further includes at least one surface having at least two grooves. The two grooves extend along a groove axis that is substantially perpendicular to a mean airflow direction and are capable of reducing the interaction between the surface and a turbulent airflow generated by the medium.

### CROSS-REFERENCE TO RELATED APPLICATION

This application claims priority from U.S. Provisional Application 60/285,511, filed Apr. 20, 2001, and entitled “Riblets on Actuator Assembly to Reduce Off-track Flow Induced Vibration.”

### FIELD OF THE INVENTION

The present invention relates to fluid flow within a data storage device. In particular, the present invention relates to internal surfaces within a data storage device that affect fluid flow.

### BACKGROUND OF THE INVENTION

In magnetic and optical disc drives, heads read and/or write data in tracks on the disc. To access different tracks, each head is supported by a suspension assembly that can move the head across the disc. In many drives, the suspension assembly applies a pre-load that brings the head toward the disc. Typically, this force is overcome by the flow of air that is created as the disc beneath the head rotates. Thus, as the disc rotates, an air bearing develops between the head and the disc allowing the head to move freely across the disc without damaging the disc or the head.

Although this airflow is necessary for lifting the head from the disc, the rotating discs cause airflow that impinges on the suspension assembly and negatively impacts on the performance of the drive. In particular, the airflow excites the mechanical resonances of the suspension assembly. These mechanical resonances cause the head to be moved off track in a non-repeatable manner creating what is known as non-repeatable run-out errors. In addition, circulating air creates vortices or eddies that interact with surfaces in the drive, thereby generating excitation forces on the surfaces. Further, the drag forces increase the power consumption within the disc drive and extract greater energy from the spindle motor to spin the disc pack.

The problems caused by turbulent air circulation are becoming more and more significant. As the disc drive areal densities continue to increase, track widths continue to decrease. As the track widths are reduced, the errors caused by windage induced resonance become more significant. Secondly, disc speeds continue to increase in an effort to reduce the time needed to reach a data sector on the disc. This increased rotational velocity increases the airflow through the disc drive, thereby worsening the negative windage effects in the drive.

Thus, improvements are needed that will reduce the negative effects caused by windage in a disc drive. Embodiments of the present invention provide a solution to this and other problems, and offer other advantages over the prior art.

### SUMMARY OF THE INVENTION

A data storage device for storing and accessing data includes a motor and at least one movable medium coupled to the motor. The motor is capable of moving the medium and thereby generating turbulent airflow. The data storage device further includes at least one surface having at least two grooves. The two grooves extend along a groove axis that is substantially perpendicular to a mean airflow direction and are capable of reducing the interaction between the surface and a turbulent airflow generated by the medium.

These and various other features as well as advantages which characterize embodiments of the present invention will be apparent upon reading the following detailed description and review of the associated drawings.

### BRIEF DESCRIPTION OF THE DRAWINGS

FIG. 1 is an isometric view of a disc drive under one embodiment of the present invention.

FIG. 2 is a perspective view of a surface with grooves under one embodiment of the present invention.

FIG. 3 is a side view of the grooved surface of FIG. 2.

FIG. 4 is a side view of an alternative embodiment of a grooved surface under the present invention.

FIG. 5 is a side view of a second alternative embodiment of a grooved surface under the present invention.

FIG. 6 is a side view of a further embodiment of a grooved surface under the present invention.

FIG. 7 is a perspective view of an E-block assembly.

FIG. 8 is a top perspective view of a suspension.

FIG. 9 is a bottom perspective view of a suspension.

FIG. 10 is a perspective view of an air dam.

FIG. 11 is a perspective view of a flow regulator.

### DETAILED DESCRIPTION OF ILLUSTRATIVE EMBODIMENTS

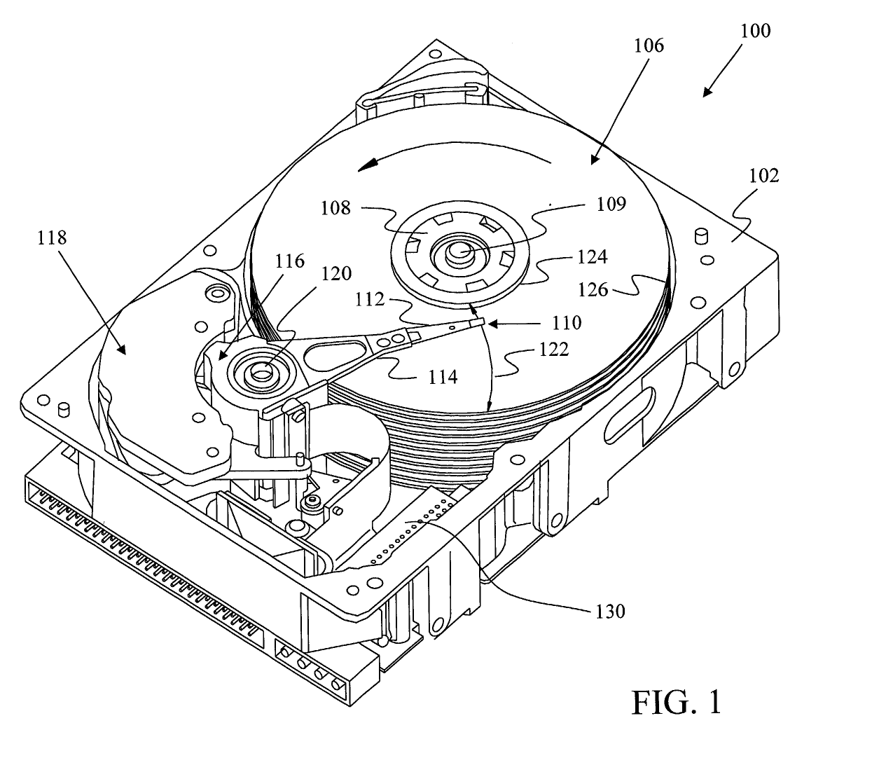

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle 109 by a disc clamp 108. Disc pack 106 includes a plurality of individual discs, which are co-rotated about spindle 109 by a spindle motor (not shown) attached to the bottom of spindle 109. Each disc surface has an associated disc head slider 110 which is mounted to disc drive 100 for communication with the disc surface. As the disc pack is rotated, it generates air circulation through the drive and in particular generates an air bearing between each head slider 110 and each disc surface.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

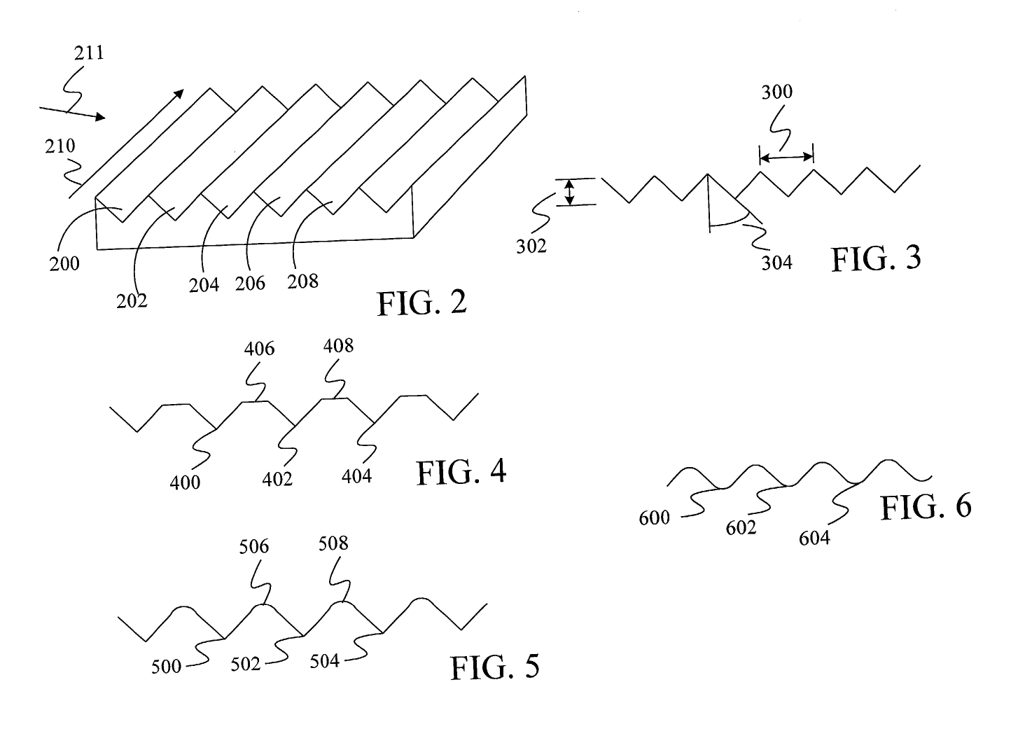

The present invention provides surface features for surfaces in the disc drive to help reduce the interaction between vortices in turbulent airflow and the surfaces in the disc drive. FIG. 2 provides a perspective view of a set of groove features under one embodiment of the present invention.

In FIG. 2, the top of the surface has a plurality of grooves 200, 202, 204, 206 and 208, which extend in a groove axis direction 210. The profile provided by the grooves of FIG. 2 cause vortices in a turbulent flow to be kept some distance above the surface, when the mean flow is in a direction 211 that is perpendicular to the groove axis. By keeping the vortices above the surface, the grooves lessen the interaction between the turbulent flow and the surface. This reduces the skin friction produced by the turbulent flow thereby reducing the excitation of the surface by the turbulent flow and reducing the conversion of the turbulent flow into heat and hence less power consumption as well.

The performance of such grooves has been investigated in connection with large aircraft where drag in turbulent conditions is an obvious concern. However, the use of such grooves in small-scale devices, particularly consumer electronics, has not been suggested.

FIG. 3 provides a side view of the grooved features of FIG. 2. In FIG. 3, the width 300 of each groove and the depth 302 of each groove can be seen. Under embodiments of the present invention, the depth 302 of the grooves is typically in a range between 0.1 milli-inches and 10 milli-inches and the width 300 is between 1 milli-inch and 20-30 milli-inches. The angle 304 of the side walls of the grooves to a line normal to the surface can be any suitable angle. However, the present inventors have found that 50° works well. Note that the height, depth and angle of the grooves can be selected as a matter of choice depending on the Reynolds number of the flow in which the surface is placed and the amount of reduction in drag that is desired.

FIG. 4 shows a side view of an alternative embodiment of the present invention in which the grooves, such as grooves 400, 402 and 404 are separated from each other by a planar region such as planar regions 406 and 408. The length of the planar regions is a matter of design choice, however, in order to obtain the benefits provided by the grooves in reducing drag, the inventors generally believe that the planar regions can be approximately a maximum of 10 to 20% of a groove length.

FIG. 5 shows a further alternative embodiment of the present invention in which grooves such as grooves 500, 502 and 504 are separated from each other by curved surfaces such as curved surfaces 506 and 508. FIG. 6 provides an additional embodiment in which grooves such as grooves 600, 602 and 604 are curved instead of being formed in a V-shape as found in FIGS. 3,4 and 5. The amount of curvature in FIGS. 5 and 6 is a matter of design choice and any amount of curvature is within the scope of the present invention.

Although several embodiments of the grooves of the present invention have been shown in FIGS. 2-6, the present invention is not limited to the particular shapes. In particular, combinations of different curved surfaces and/or planar surfaces can be used to construct the grooves within the scope of the present invention. Thus, a planar portion of the groove may be followed by a curved portion followed by another planar portion. In fact, any shaped depression that could be used to form a series of grooves is within the scope of the present invention.

In addition, the grooves do not need to form straight lines as is shown in FIG. 2. Under some embodiments, the grooves will form curved patterns on the surface so that the groove axis at any one point along the curve remains substantially perpendicular to the mean flow direction (direction of the bulk flow velocity vector).

The surface features of FIGS. 2 through 6 may be applied to any surface in the disc drive. Applicants note however that particular advantage can be found in applying these surface features to the surfaces of the E-block assembly, the suspension, air dams, and air regulators.

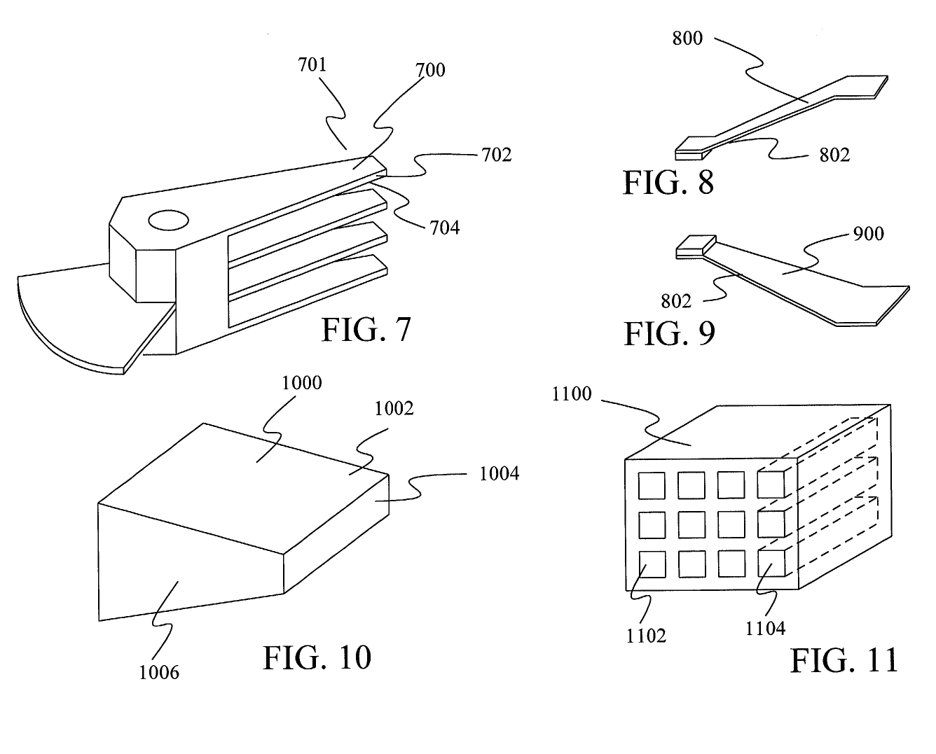

FIG. 7 shows a perspective view of an E-block assembly on which any of the surface features of FIGS. 2-6 may be applied. In FIG. 7, the surface features can be applied to the top surface of any of the fingers of the E-block such as top surface 700 of finger 701 or the bottom surface of any of the fingers of the E-block such as bottom surface 702. In addition, the grooved surface features may be applied to the leading edge of any of the fingers of the E-block assembly, such as leading edge 704. Note that when applying the grooved surface features, the groove axis should be placed on the E-block assembly such that the mean flow over the E-block assembly will be perpendicular to the groove axis.

Also note that the E-block assembly does not remain in the same position over the disc but instead rotates above the disc surface. As a result, the E-block will be at different “skew” angles to the direction of rotation of the disc when it is at different positions over the disc. Because of this skew, it is impossible to maintain the groove axis perpendicular to the mean flow at all positions over the disc. Instead, the best that usually can be done is to make the grooves perpendicular to the mean flow direction at one position over the disc. Under one embodiment, the groove axis is made perpendicular to the mean flow at the radial location where non-repeatable run-out is most harmful to proper positioning of the head.

FIG. 8 and FIG. 9 provide a top perspective view and a bottom perspective view, respectively, of a suspension assembly. Under one embodiment, the surface features of FIGS. 2-6 may be applied to the top and bottom surface 800 and 900 of suspension arm 802. As with the E-block assembly, one embodiment positions the surface features such that the groove axis is perpendicular to the mean flow at the radial position at which the non-repeatable run-out is most significant.

FIG. 10 provides a perspective view of an air dam on which the features of FIGS. 2-6 may be applied. Such air dams are placed between the discs within the disc drive to control airflow between the discs. In particular, these features may be applied to any of the surfaces of air dam 1000 including surfaces 1002,1004 and 1006. Any of the surface features of FIGS. 2-6 may also be applied to an air regulator such as air regulator 1100 of FIG. 11. Air regulator 1100 includes air channels such as air channels 1102 and 1104 that pass through the body of air regulator 1100. Any of the surface features of FIGS. 2-6 may be applied to any of the exterior surfaces of air regulator 1100 and may be applied to the interior surfaces of each of the channels such as channels 1102 and 1104.

Any of several known techniques for altering the surface of a structure can be used to form the grooves of FIGS. 2-6. In particular, partial etching, electroplating, stamping, selective cutting or molding processes could be used to form the structures of FIGS. 2-6. In addition, deposition techniques can be used instead of removal or stamping techniques by depositing structures in spaced relation to each other such that grooves are formed between the structures. Note that the particular method selected depends on the location of the surface and the material being manipulated. For example, because of the small size of the suspension, the grooves would typically be formed on the suspension through partial etching or electroplating, while stamping or cutting could be used on the E-block since the E-block is much larger.

The grooves of FIGS. 2-6 may be used on any type of material within the disc drive and on any surface within the disc drive. In particular, the grooves could be applied to the bottom, top and side plates found within the disc drive. Applicants note however that in locations of laminar flow, the additional grooves will cause additional friction between the airflow and the surface. Thus, it may not be desirable to apply the surface features to all of the surfaces within the disc drive.

In summary, a data storage device (such as 100) is provided with a motor and at least one moveable medium (such as 106) coupled to the motor and capable of being moved by the motor. At least one internal surface (such as 700, 702, 704, 800, 900, 1002, 1004, 1006) has at least two grooves (such as 200, 202, 204, 206, 208, 400, 402, 404, 500, 503, 504, 600, 602, 604) having a groove axis (such as 210) that is substantially perpendicular to a mean airflow direction (such as 211). The two grooves being capable of reducing interaction between the internal surface and a turbulent airflow generated by the medium (such as 106).

In the several embodiments, the internal surface can have at least three evenly spaced grooves (such as 204, 206, 208), the grooves can be V-shaped (such as 204, 206, 208) or curved (such as 600, 602, 604), the grooves can be separated by a planar surface (such as 406, 408) or a curved surface (such as 506, 508), and the grooves can appear on an E-block assembly (such as 701), a suspension (such as 802), an air dam (such as 1000), and/or an air flow regulator (such as 1100).

A surface (such as 700, 702, 704, 800, 900, 1002, 1004, 1006) for a component in a disc drive (such as 100) is also provided. The surface includes a first groove (such as 200, 400, 500, 600) and a second groove (such as 202, 402, 502, 602) that have a groove axis (such as 210) that is substantially perpendicular to a mean airflow direction (such as 211) such that the first and second grooves cooperate to reduce interaction between vortices and the surface.

In the several embodiments, the first groove and the second grove can be V-shaped (such as 204, 206, 208) or curved (such as 600, 602, 604), can border each other (such as 204, 206, 208, 600, 602, 604), can be separated from each other by a planar surface (such as 406,408) or a curved surface (such as 506, 508), and can appear on an E-block assembly (such as 701) and/or a suspension (such as 802).

A disc drive (such as 100) for storing and accessing data includes a moving medium (such as 106) that generates an airflow having eddies in the disc drive (such as 100). Excitation reduction means defining a surface in the disc drive for reducing the excitation of the surface by causing eddies in the airflow to be moved away from the surface.

In several embodiments, the excitation reduction means comprises grooves on the surface. These grooves can be V-shaped or curved and can be evenly spaced from each other.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the surface features within a small-scale device while maintaining substantially the same functionality without departing from the scope and spirit of the present invention. In addition, although the preferred embodiment described herein is directed to surface features for a data storage device, it will be appreciated by those skilled in the art that the teachings of the present invention can be applied to other small-scale systems, like portable CD players or mini-disc systems, without departing from the scope and spirit of the present invention.

What is claimed is:

1. A data storage device for storing and accessing data, the storage device comprising:
a motor;
at least one movable medium coupled to the motor and capable of being moved by the motor and thereby generating a turbulent airflow; and
at least one internal surface comprising at least two grooves having a groove axis oriented substantially perpendicular to a mean airflow direction so as to reduce interaction between the internal surface and a turbulent airflow generated by the medium.

2. The data storage device of claim 1 wherein the internal surface comprises at least three evenly spaced grooves.

3. The data storage device of claim 1 wherein the grooves are V-shaped.

4. The data storage device of claim 1 wherein the grooves are curved.

5. The data storage device of claim 1 wherein the grooves are separated by a planar surface.

6. The data storage device of claim 1 wherein the grooves are separated by a curved surface.

7. The data storage device of claim 1 wherein the internal surface forms part of an E-block assembly.

8. The data storage device of claim 1 wherein the internal surface forms part of a suspension.

9. The data storage device of claim 1 wherein the internal surface forms part of an air dam.

10. The data storage device of claim 1 wherein the internal surface forms part of an air flow regulator.

11. A surface for a component in a disc drive, the surface comprising;
a first groove having a groove axis that is substantially perpendicular to a direction of expected mean air flow; and
a second groove proximate the first groove and having a groove axis that is substantially perpendicular to the expected mean air flow such that the first and second grooves cooperate to reduce interaction between vortices in the air flow and the surface.

12. The surface of claim 11 wherein the first groove and the second groove are V-shaped.

13. The surface of claim 11 wherein the first groove and the second groove are curved.

14. The surface of claim 11 wherein the surface forms part of an E-block assembly.

15. The surface of claim 11 wherein the surface forms part of a suspension.

16. The surface of claim 11 wherein the first groove borders the second groove.

17. The surface of claim 11 wherein the first groove is separated from the second groove by a planar surface.

18. The surface of claim 11 wherein the first groove is separated from the second groove by a curved surface.

19. A disc drive for storing and accessing data, the disc drive comprising:
a moving medium that generates an airflow having eddies in the disc drive; and
excitation reduction means defining a surface in the disc drive for reducing the excitation of the surface by causing eddies in the airflow to be moved away from the surface.

20. The disc drive of claim 19 wherein the excitation reduction means comprises grooves on the surface.

21. The disc drive of claim 20 wherein the grooves are V-shaped.

22. The disc drive of claim 20 wherein the grooves are curved.

23. The disc drive of claim 20 wherein the grooves are evenly spaced.
